(19) United States
(12) Patent Application Publication
(10) Pub. No.: US 2009/0018722 A1
(43) Pub. Date: Jan. 15, 2009

(54) PROCESS FOR PROVIDING REPLACEMENT ELECTRIC MOTORS

(76) Inventor: Timothy Fielding, Galesburg, MI (US)

Correspondence Address: Flynn, Thiel, Boutell & Tanis, P.C, 305B WATERS BUILDING, 161 Ottawa Ave., N.W., Grand Rapids, MI, 49503, US

(21) Appl. No.: 12/172,700

(22) Filed: Jul. 14, 2008

Related U.S. Application Data
(60) Provisional application No. 60/949,253, filed on Jul. 12, 2007.

(51) Int. Cl. G06Q 50/00; H02K 15/00; G06Q 10/00

(52) U.S. Cl. 701/33; 434/107; 29/596; 705/28

(57) ABSTRACT

A process for providing replacement electrical motors to a number of disparate users that employ large, industrial electric motors for driving electrical generators or other rotary equipment. The process comprises providing a cooperative motor repair and replacement program and alliance for the repair and replacement of the electric motors; ascertaining the specifications and condition of the motors of each user who participates in the program, and transferring the motors of each user to one or more common climate-controlled storage locations, so that they will be in good condition and available when required. Desirably, the inventory of the user's own motors is supplemented by new motors in a sufficient quantity to satisfy the replacement motor requirements of all the users. To the extent required, an inventory is maintained of transition bases that are used to position a replacement motor so that it matches the specifications of the driven apparatus. The replacement motors and transition bases of the alliance serve to supply the needs of all of the members of the alliance, so that each member of the alliance does not have to maintain a complete inventory of replacement motors. Desirably, motor removal is accomplished at the same time that the replacement motor is transferred to the user's location, enhancing the speed of motor exchange, and minimizing inventory requirements.

### CROSS REFERENCE TO RELATED APPLICATION

This application is a non-provisional application based on and claiming the priority date of Applicant's co-pending provisional application Ser. No. 60/949,253, filed Jul. 12, 2007, and entitled, PROCESS FOR PROVIDING REPLACEMENT ELECTRIC MOTORS, the disclosure of which is incorporated herein by reference.

### BACKGROUND OF THE INVENTION

The present invention relates to a process for providing replacement electric motors of the type that are used to drive commercial electrical generating equipment and the like.

Electrical generators employed by electrical utilities and power companies are driven by large, industrial electric motors. These motors are operated twenty-four hours a day, seven days a week for as long as they remain operational. When they break down, or are about to break down, they are replaced with replacement motors maintained in inventory by the energy company. Each energy company maintains its own supply of electric motors in such storage facilities as may be available. Generally, the storage facilities are not optimum for maintaining the motors in the required physical condition. Also, the quantity of motors, the condition of the motors, and the location of the motors is often uncertain or unknown. As a result, when a motor needs replacement, a replacement motor often cannot be found, and when it is found, it is learned, too late, that the motor is in unsatisfactory condition for use. The problem with this is that down time is extraordinarily expensive for power companies that are required to shut down while a motor is being repaired or replaced.

Maintaining an inventory of motors also presents a financial problem for an energy company. An inventory of motors, which are quite expensive, is a capital investment that must be maintained on the books of the energy company.

This same scenario is present with virtually all energy companies and other companies that employ large industrial electric motors, particularly when the motors are so-called “critical path” motors, which means that the motors are critical to operation of the business such that the business operation (e.g. electrical generation or product production) stops if the motor fails. The problem is especially acute where the motors are so-called “large frame” motors. These are motors larger than so-called “NEMA frame” motors, which means a motor that is larger than the motors maintained in inventory by typical local electrical supply companies. Such motors may not be locally available and involve greater replacement difficulties. While all users of critical path, large frame electric motors experience replacement and repair difficulties, for exemplary purposes the present invention is described in the context of an electrical energy company.

At the present time each energy company struggles with its own replacement motor problems. Many energy companies employ substantially the same type of electric motor to drive its driven apparatus, such as electrical generators and other equipment (such as the equipment identified in FIG. 10). The operating characteristics of these motors functionally can be similar. However, the manner in which the motors are coupled to a load (such as a generator or other equipment or driven apparatus) makes replacement at the present time a somewhat unique situation. Large motors drive generators and other driven apparatus by coupling the ends of the drive shaft of the motor with the driven shaft of the apparatus, typically in end to end alignment. The base or bed on which the motor is mounted is thus constructed such that motor drive shaft is in alignment with the driven shaft of the apparatus. The physical position of drive shafts of different electric motors can be somewhat different, making the physical connection of the electric motor unique to a particular driven apparatus. In addition, when electric motors are rebuilt or replaced with a new electric motor, new parts are frequently smaller and more compact, and this causes the replacement motor to have a drive shaft at a different location than the drive shaft of the larger motor that is being replaced.

In order to accommodate differences in drive shaft location, transition bases are sometimes employed. A transition base is mounted between the motor and the concrete base on which the motor assembly is mounted, adjusting the height of the motor drive shaft to a desired location. A particularly desirable transition base is disclosed in applicant's co-pending patent application Ser. No. 11/573,822, filed Feb. 16, 2007, which is incorporated by reference. Applicant's transition base not only provides drive shaft position adjustment, but also dampens vibration generated by the electric motor.

An object of the present invention is to provide a process by which capital expenditures for motors can be minimized while the availability of replacement and repaired motors can be maximized, and motor repair, replacement, and maintenance can be undertaken by professionals who are especially well trained for this specific task.

### SUMMARY OF THE INVENTION

The present invention relates to a system where a number of disparate users employ large, industrial electric motors for the purpose of driving electrical generators or other rotary equipment or apparatus by coupling of driving and driven drive shafts, the motors including a plurality of motors of comparable sizes and capacities, such that at least some of the motors of one user are functionally interchangeable with motors of one or more other users, with the driven rotary equipment for the disparate users having drive shaft position characteristics that require matching by the electric motor drive shaft coupled thereto, and where electric motor drive shaft position can vary in rebuilt or replacement electric motors in comparison with the original motors that are being rebuilt or replaced.

The present invention constitutes an improvement in the system comprising a process for repairing and replacing electric motors for the disparate users comprising providing a cooperative motor repair and replacement program and alliance for the repair and replacement of the electric motors, such that users can join the alliance in order to participate in the repair and replacement program. The program comprises the steps of:
conducting an assessment of the motor requirements of the users who participate in this program, such assessment including determining the specifications and condition of each user's motor. This desirably includes determining the nature and number of each type of electric motor, determining the age, condition, and state of repair of each motor, determining the number and condition of replacement motors being maintained by each user; and determining the motor and position requirements of the driven apparatus;
transferring the replacement motors to one or more climate controlled storage locations so as to be made available at least to the user that owns each motor. The motors of disparate users who agree to share motors constituting a replacement inventory for users of like motors;
desirably maintaining, in addition to replacement motors of the users, an inventory of new or rebuilt motors in the storage location in sufficient numbers that the new or rebuilt motors, in addition to the replacement motors of the users, are sufficient to satisfy the reasonably anticipated needs of all of the users for repaired or replacement motors;
providing transition bases for the replacement motors to the extent required, such that a replacement motor can be supplied along with a transition base that matches the specifications of the replacement motor with the specifications of the driven apparatus, so that the drive shaft and driven shaft thereof can be coupled together; and
providing a replacement motor and transition base, to the extent required, in exchange for a motor needing repair or replacement, with the removal of the motor requiring repair or replacement being performed at the same time that the replacement motor is being transferred to the user's location, whereby the speed of motor exchange is enhanced and the inventory of replacement parts and replacement motors is minimized, and the motors are stored and maintained by specialists in the repair, rebuilding, and storage of motors.

These and other features and advantages of the present invention will hereinafter appear. For purposes of illustration, but not of limitation, a preferred embodiment of the present invention is described below and illustrated in the attached drawings.

### BRIEF DESCRIPTION OF THE SEVERAL VIEWS OF THE DRAWING

FIGS. 1-17 are charts or diagrams demonstrating the manner in which the process of the present invention is carried out.

### DETAILED DESCRIPTION OF THE INVENTION

In accordance with the present invention, the present system of motor maintenance (wherein disparate energy companies are each responsible for maintaining replacement motors, replacing motors and servicing the motors) is replaced by a single cooperative venture or alliance that maintains a common inventory of motors for all users that are members of the alliance. The alliance desirably is a joint venture or other business entity in which a number of disparate energy companies are members. The alliance desirably is professionally managed by one or more operating companies having special expertise in the sale, maintenance, repair, and replacement of electric motors. The alliance can, for example, include a company or entity that maintains an inventory of replacement motors and stores and trades electric motors from this inventory. Another company or a branch of the same company can be set up to provide maintenance, repair, and rebuilding services for electric motors. Another company or branch of the same company can provide a specially trained workforce for removal and installation of motors at a member's worksite and onsite repair, when appropriate.

The present invention provides a process for maintaining, repairing, and replacing electric motors for disparate users who combine together to provide a motor supply system that is vastly superior to the individual motor maintenance systems that are currently being maintained by each individual energy company.

In the present invention, professional management of the alliance of individual power companies (“motor users”) performs the following functions:

The status of motor requirements and replacement parts and motors of each motor user is established and inventoried. Each user is entitled to retain its own inventory of replacement motors, parts and products as its own property, or it has the right to transfer its rights to the inventory to the alliance in exchange for appropriate credit for its contribution.

Each motor to be used by the alliance is inspected by a professional service company and repaired to the extent necessary to place it in a ready condition for use.

All of the replacement motors provided by the motor users are transferred to one or more appropriate, climate controlled warehouses operated by the alliance and maintained by professional personnel in a manner to ensure that each motor is ready and available at all times for immediate dispatch to a location where it is required. A complete database of all available equipment is maintained so that an appropriate replacement motor can always be located. Electronic tags can be employed to physically locate each replacement motor.

To the extent that the inventory of replacement motors contributed by the members of the alliance is unsatisfactory to provide a reasonably sufficient quantity of replacement motors for anticipated needs, new or rebuilt replacement motors are acquired by the alliance and maintained in inventory along with other electric motors contributed by the members of the alliance. The number of motors required for a plurality of users is substantially less than the number of backup motors that each member would require operating individually. Whereas a member with one operating motor of a particular type might require a backup or replacement motor for that one operating motor, this same replacement motor could serve as a contingent replacement for numerous companies that require a backup motor of that particular type. With the ability to repair and rebuild motors expeditiously and with the ability to predict the life of existing motors, a reasonably accurate estimate can be made of the number of motors that are necessary to be maintained in inventory in order to supply the repair or replacement needs of motors of many disparate users.

Aside from the advantage that fewer motors are necessary to be maintained in inventory, another advantage is that the substantial capital expense represented by each motor does not have to be maintained by each user. Instead, the alliance can maintain the capital expense.

Because of the different physical requirements of each motor installation, wherein the base for the motor is positioned at a certain height above the level of a floor, in order to maintain alignment between the motor drive shaft and the driven shaft of the generator or other electrical apparatus, transition bases are provided when necessary in order to match an electric motor with a driven apparatus having a driven shaft at a particular location above the floor. Drive shaft height varies more widely than the horsepower and other specifications of the motor. Transition bases are provided in order to restrict the number of motors that are necessary in order to supply the replacement needs of different users. A transition base is matched with a motor from database information maintained by the alliance, so that the installation will be assured of having an exact fit between the driven apparatus and the electric motor.

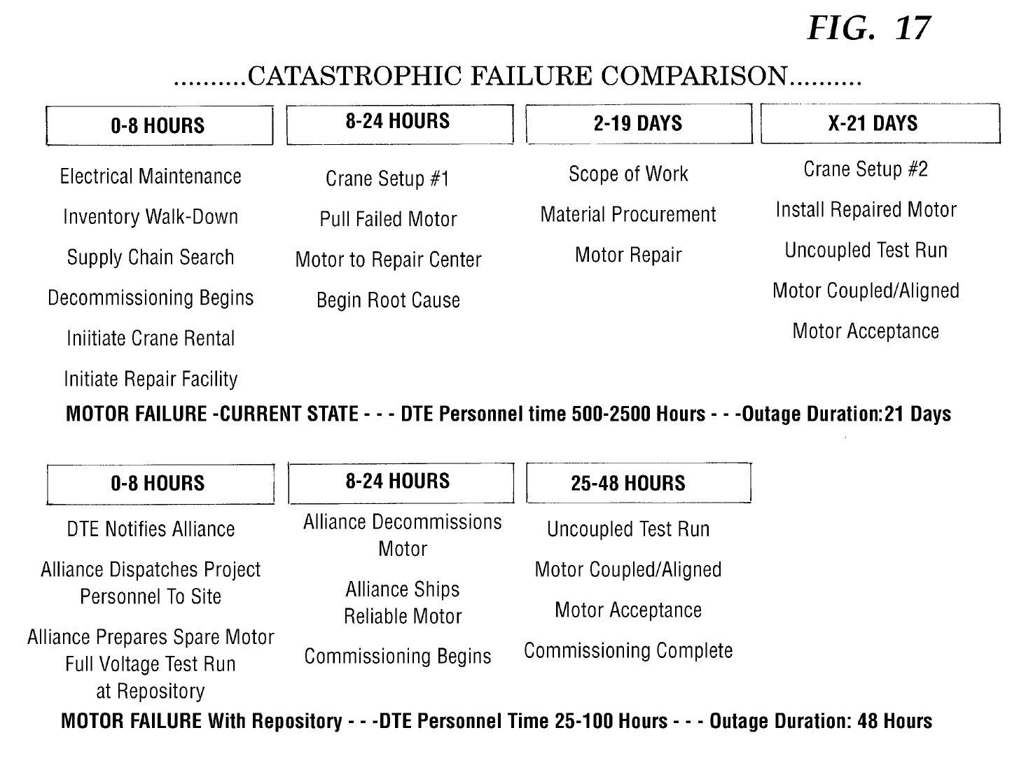

Whenever a motor breaks down or is otherwise scheduled for replacement, this can be accomplished expeditiously. The user contacts the alliance. The alliance locates the replacement motor and appropriate transition base, if necessary, and initiates shipment procedures immediately. At the same time, service personnel are dispatched to the user's location to remove the failed motor. By the time the replacement motor arrives, the failed motor has been removed and shipped to a service location for refurbishing. The service personnel then install the replacement motor and place the motor back in operation. As reflected in FIG. 17, an outage or down time of up to twenty-one days with a conventional system is replaced by an outage duration of only about forty-eight hours with the motor replacement process of the present invention.

The figures attached hereto illustrate in presentation format how the process of the present invention works to minimize capital expense, minimize down time or outage due to motor failure, and maximize efficiency in maintaining, repairing, and replacing electric motors.

For the most part the figures of self-explanatory and will only be described briefly herein.

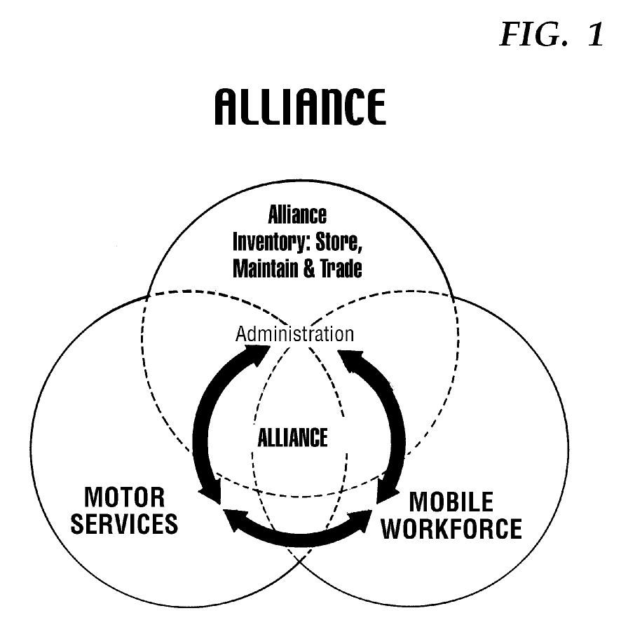

FIG. 1 illustrates that the alliance comprises an entity that stores, maintains and exchanges or trades motors, a motor service arm that services motors, and a mobile work force that replaces motors.

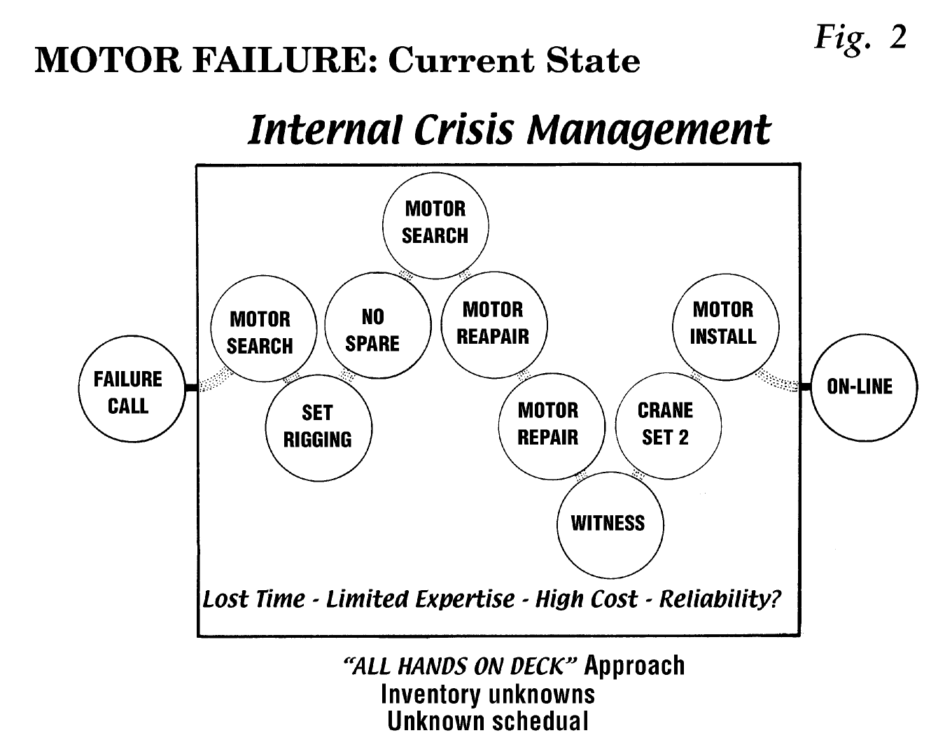

FIG. 2 illustrates the difficulty with the current state of affairs, wherein each operator of a critical path, large frame electric motor operates independently. When a motor fails, the user first searches for a spare motor. Finding none, the user conducts a search for a motor from another source. In the meantime, an expensive crane must be rented, and the rigging must be set up to remove the motor. If a replacement motor has not been found, the original motor is dispatched for repair. Repair can take a considerable amount of time and must be witnessed or tested. A crane is then rented for a second time for reinstallation of the motor. When reinstalled, the motor can be placed back on line. Each step is performed separately, and the whole process can take up to 21 days or so as reflected in FIG. 17.

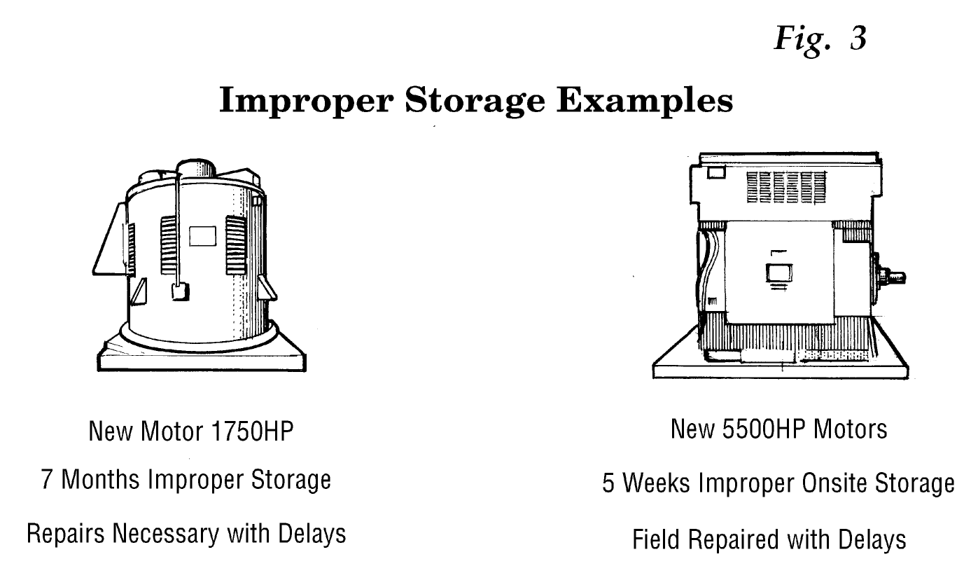

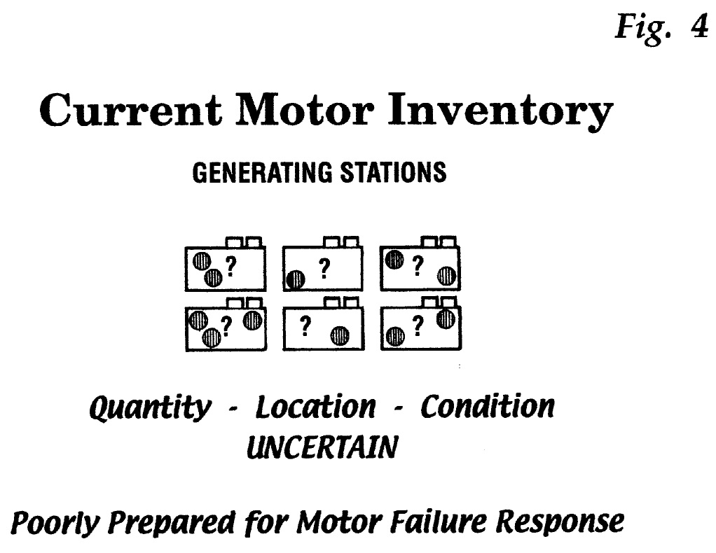

Inventories of spare motors and parts being maintained by individual users are illustrated in FIGS. 3 and 4. Improper storage is common place. Replacement motors frequently require repairs before reinstallation. In addition, the existence of and storage location of replacement motors is sometimes poorly documented, so replacement motors are sometimes difficult to locate.

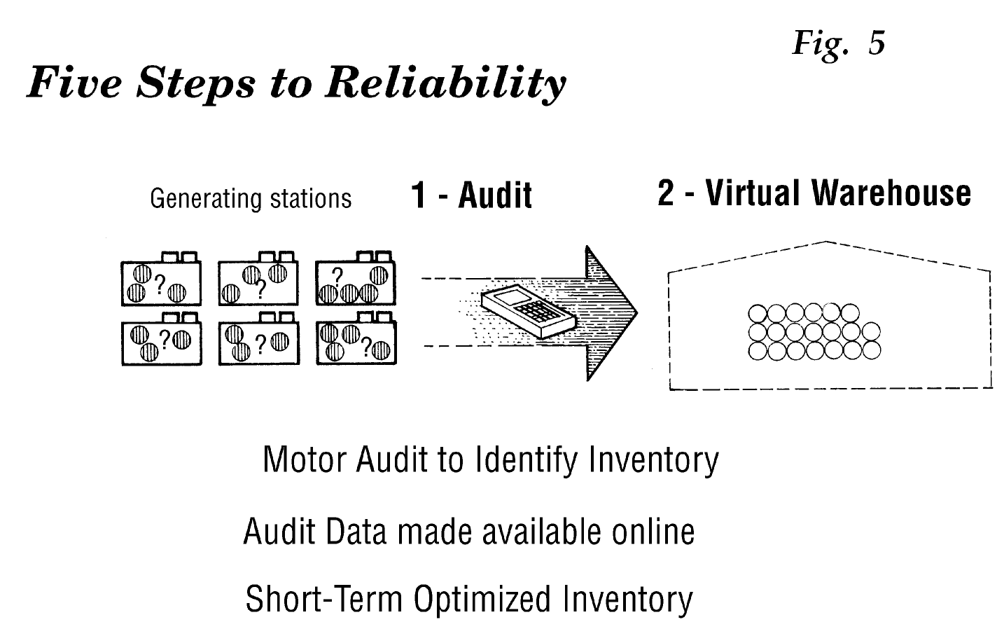

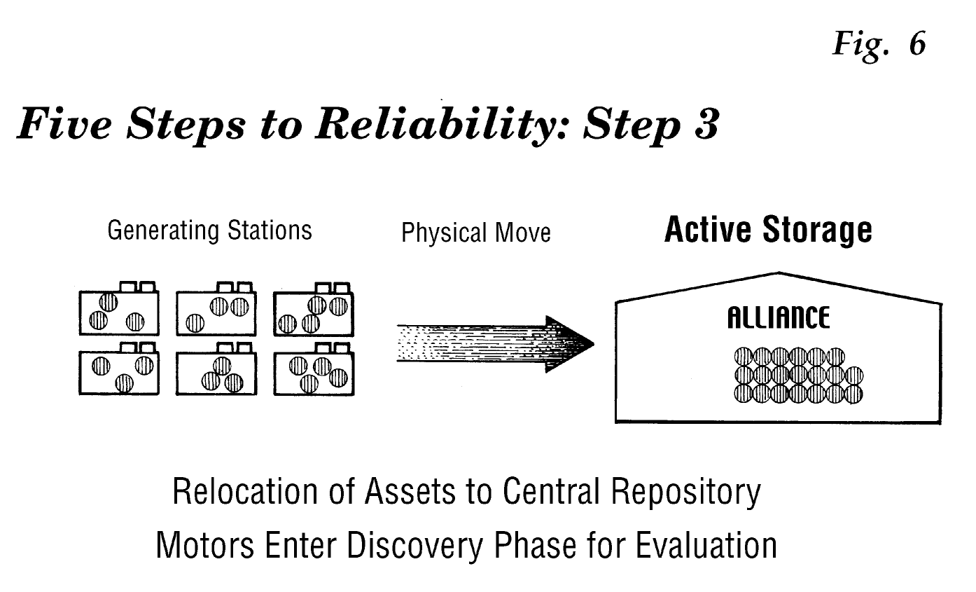

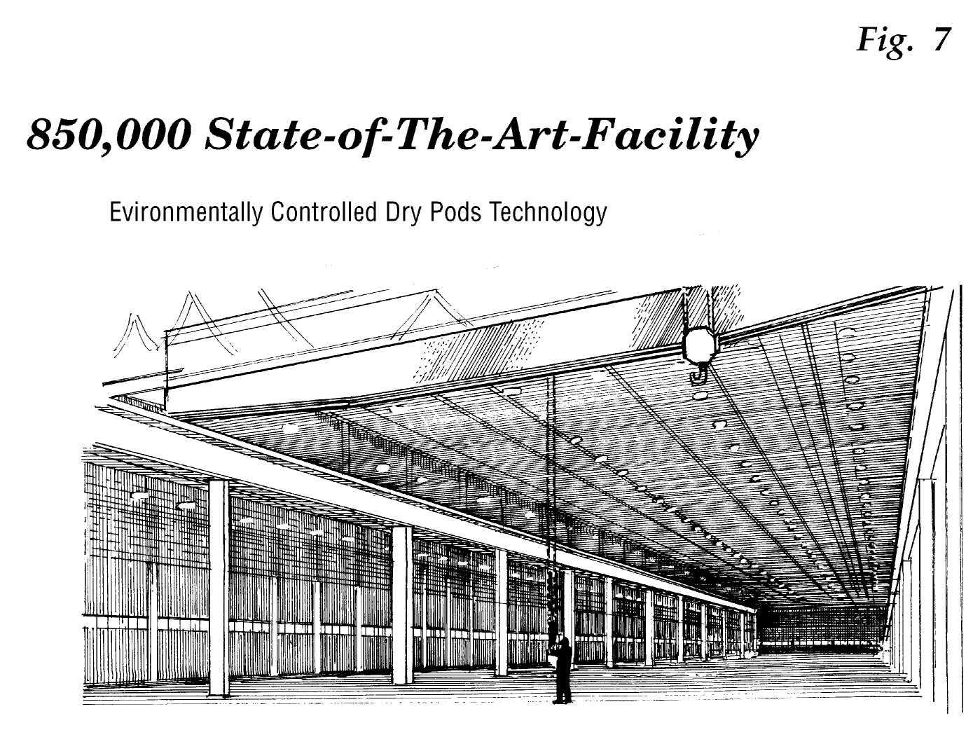

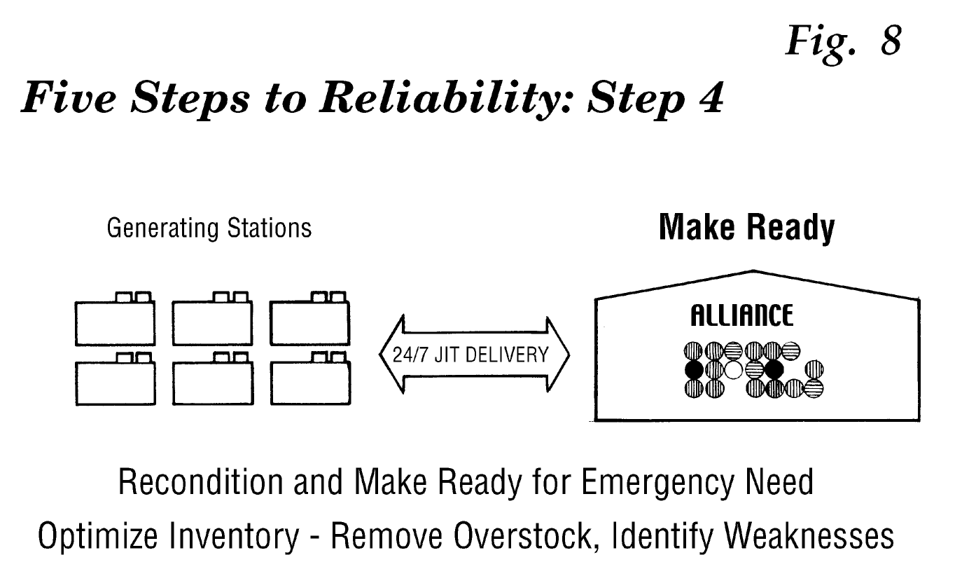

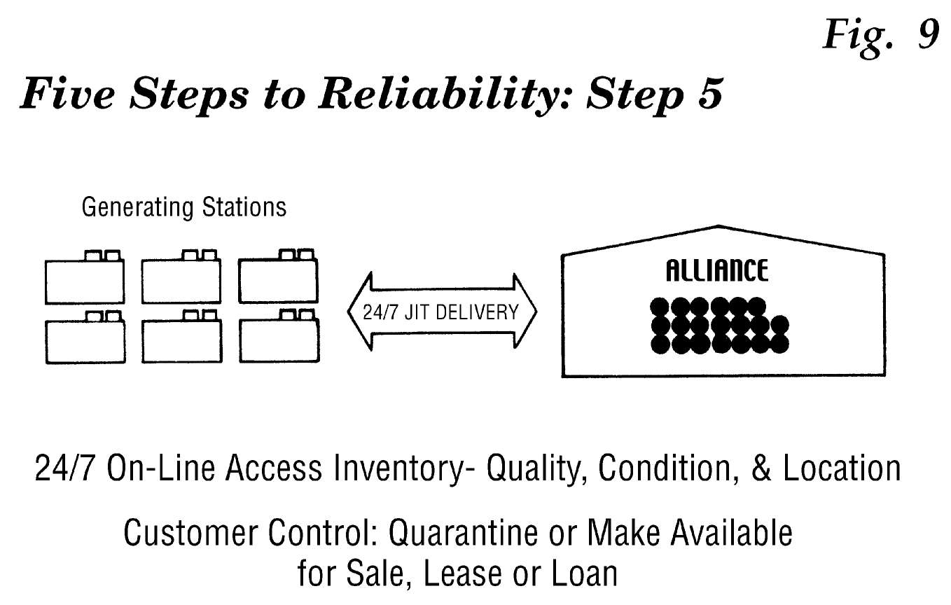

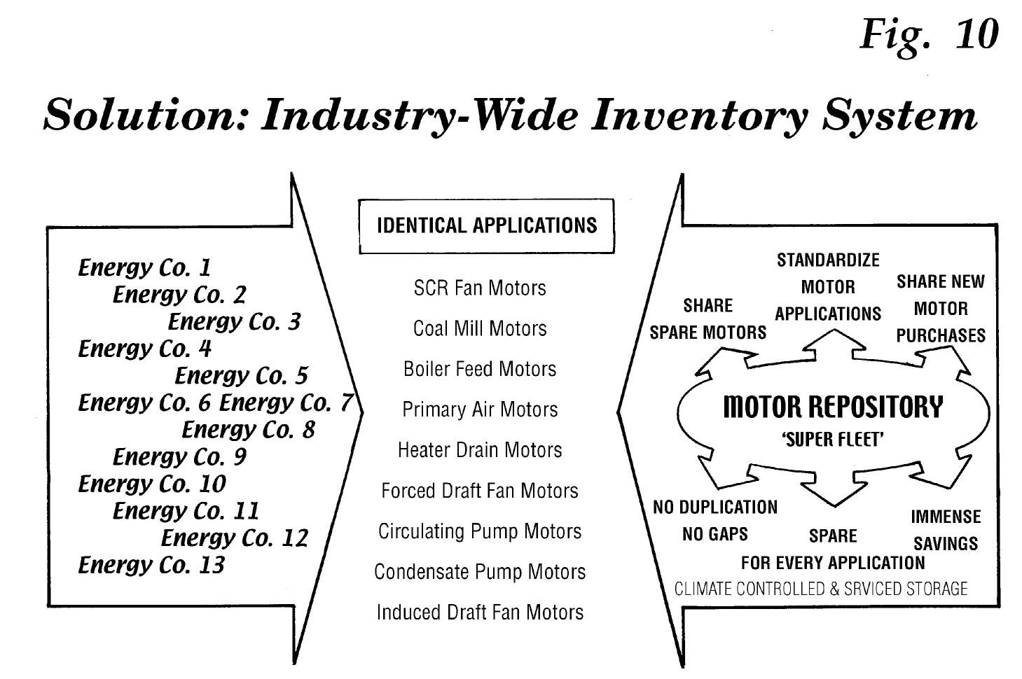

FIGS. 5 and 6 illustrate five steps to reliability that are accomplished with the process of the present invention. A state of the art storage facility is illustrated in FIG. 7. FIG. 10 illustrates how different members of an alliance share a number of identical motor applications and can employ a common fleet of replacement motors pursuant to the alliance in order to minimize expense and turn-around time for exchange of motors for repair or replacement.

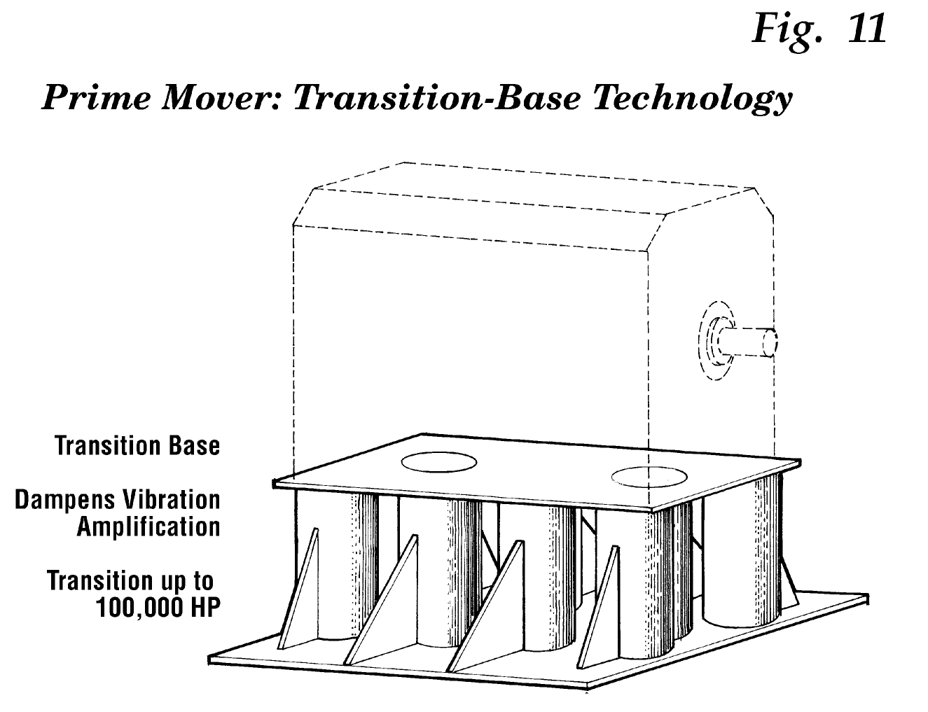

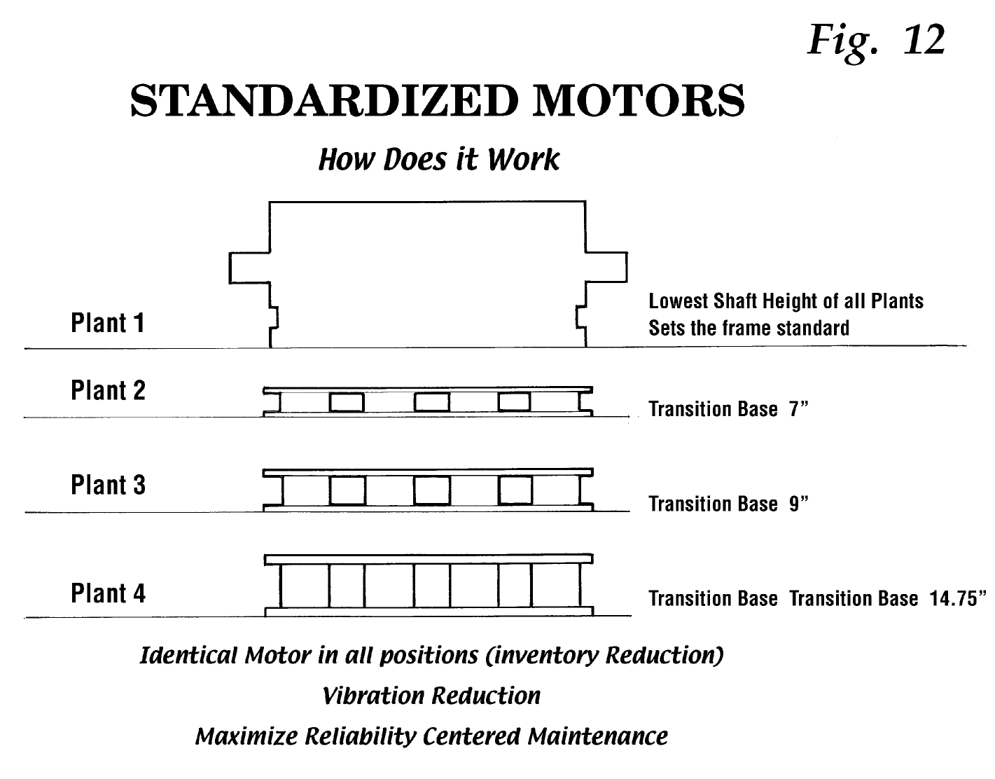

The use of transition bases, such as in applicant's co-pending patent application, in order to adapt replacement motors to the size of existing driven apparatus is illustrated in FIGS. 11 and 12.

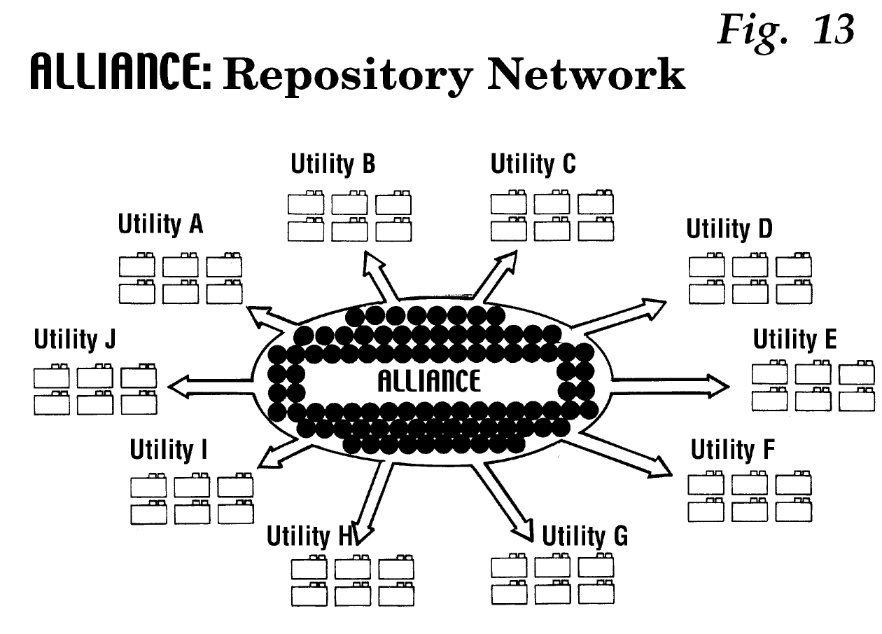

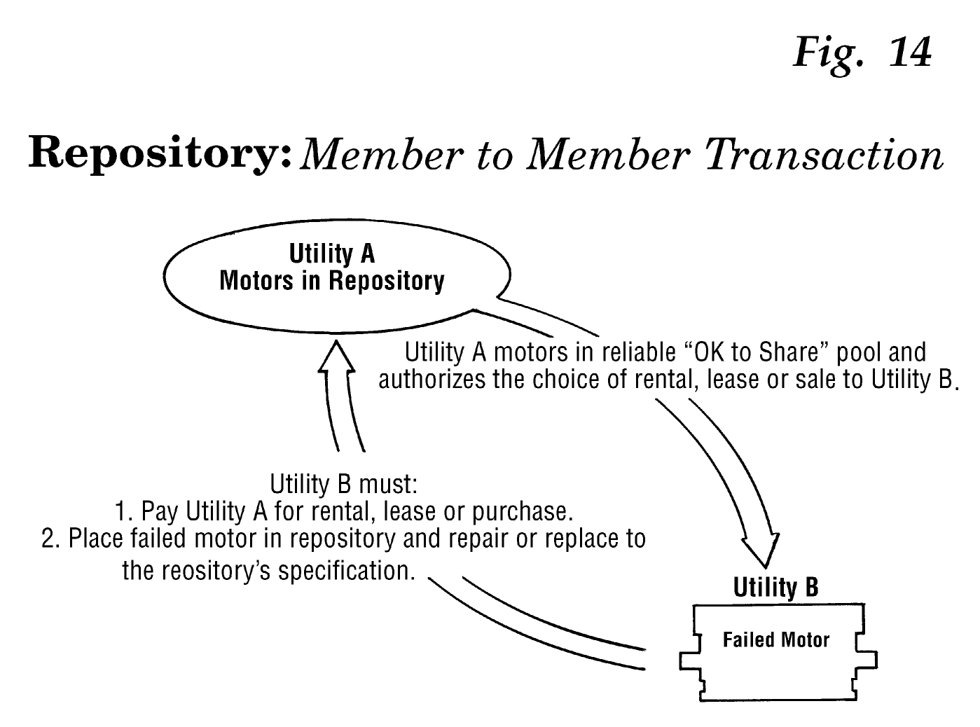

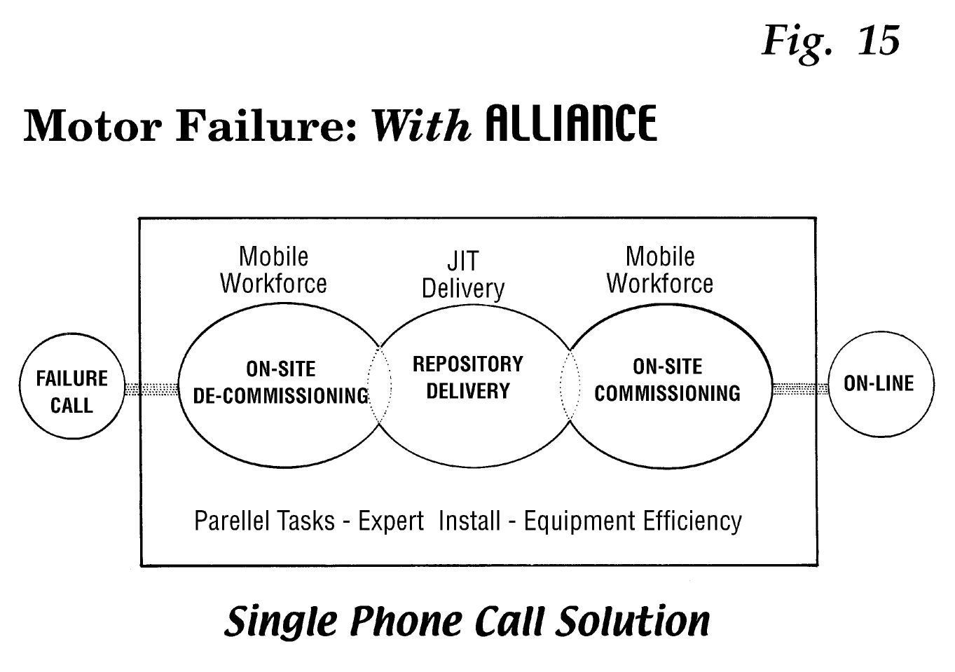

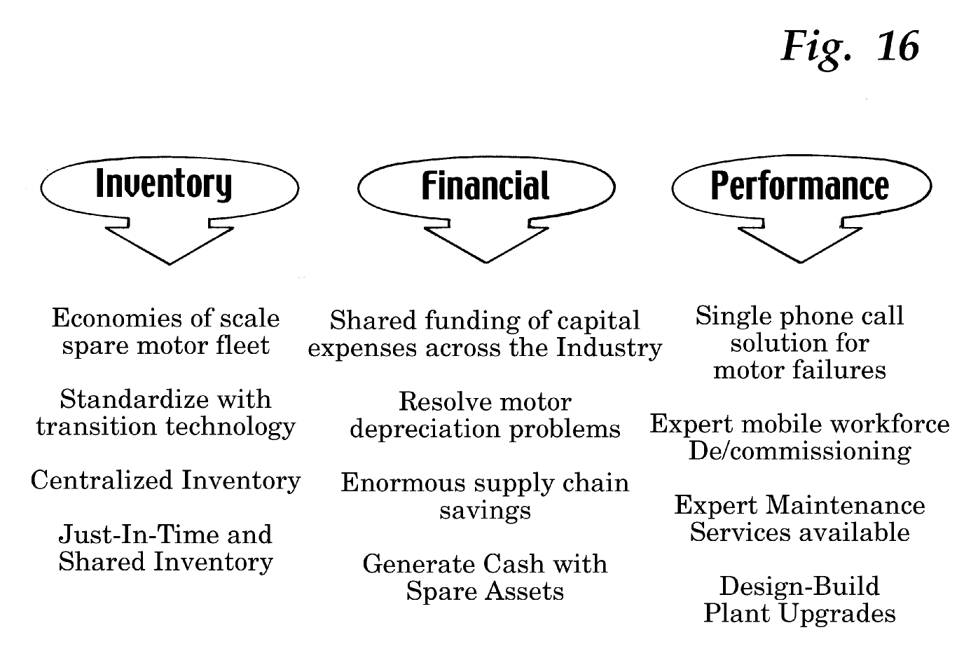

The function of a common repository network to serve the needs of different utility companies from a common inventory is illustrated in FIG. 13. A typical transaction involving the replacement of a motor from inventory is illustrated in FIG. 14. FIG. 15 illustrates how, with a single phone call, the process of removing the failed motor and replacing it with a replacement motor can be accomplished simultaneously, providing the savings in time reflected in the illustration in FIG. 17. A chart of the inventory, financial and performance advantages is reflected in FIG. 16. The foregoing is merely exemplary of the preferred practice of the present invention. Various changes in the arrangements and details of operation of the process of the present invention may be made without departing from the spirit and scope of the present invention.

I claim:

1. In a system where a number of disparate users employ large, industrial electric motors for the purpose of driving electrical generators or other rotary equipment or apparatus by coupling of driving and driven drive shafts, the motors including a plurality of motors of comparable sizes and capacities, such that at least some of the motors of one user are functionally interchangeable with motors of one or more other users, with the driven rotary equipment for the disparate users having drive shaft position characteristics that require matching by the electric motor drive shaft coupled thereto, and where electric motor drive shaft position can vary in rebuilt or replacement electric motors in comparison with the original motors that are being rebuilt or replaced, the improvement comprising a process for repairing and replacing electric motors for the disparate users comprising:
providing a cooperative motor repair and replacement program and alliance for the repair and replacement of the electric motors, such that users can join the alliance in order to participate in the repair and replacement program;
conducting an assessment of the motor requirements of the users who participate in this program, such assessment including the specifications and condition of each user's motor.
transferring the replacement motors to one or more climate controlled storage locations so as to be made available at least to the user that owns each motor, the motors of disparate users who agree to share motors constituting a replacement inventory for users of like motors;
maintaining, in addition to replacement motors of the users, an inventory of new or rebuilt motors in the storage location in sufficient numbers that the new or rebuilt motors, in addition to the replacement motors of the users, are sufficient to satisfy the reasonably anticipated needs of all of the users for repaired or replacement motors;
providing transition bases for the replacement motors to the extent required, such that a replacement motor can be supplied along with a transition base that matches the specifications of the replacement motor with the specifications of the driven apparatus, so that the drive shaft and driven shaft thereof can be coupled together; and
providing a replacement motor and transition base, to the extent required, in exchange for a motor needing repair or replacement.

2. A process accordingly to claim 1 wherein determining the specifications and condition of the users' motors includes determining the nature and number of each type of electric motor, determining the age, condition, and state of repair of each motor, determining the number and condition of replacement motors being maintained by each user, and determining the motor and position requirements of the driven apparatus.

3. A process accordingly to claim 1 wherein the removal of the motor requiring repair or replacement is performed at the same time that the replacement motor is being transferred to the user's location, whereby the speed of motor exchange is enhanced and the inventory of replacement parts and replacement motors is minimized.

4. A process according to claim 1 wherein the motors are stored and maintained by specialists in the repair, rebuilding, and storage of motors.

5. In a system where a number of disparate users employ large, industrial electric motors for the purpose of driving electrical generators or other rotary equipment or apparatus by coupling of driving and driven drive shafts, the motors including a plurality of motors of comparable sizes and capacities, such that at least some of the motors of one user are functionally interchangeable with motors of one or more other users, with the driven rotary equipment for the disparate users having drive shaft position characteristics that require matching by the electric motor drive shaft coupled thereto, and where electric motor drive shaft position can vary in rebuilt or replacement electric motors in comparison with the original motors that are being rebuilt or replaced, the improvement comprising a process for repairing and replacing electric motors for the disparate users comprising:
providing a cooperative motor repair and replacement program and alliance for the repair and replacement of the electric motors, such that users can join the alliance in order to participate in the repair and replacement programs;
conducting an assessment of the motor requirements of the users who participate in this program, such assessment including determining the specifications and condition of each user's motor, the nature and number of each type of electric motor, determining the age, condition, and state of repair of each motor, determining the number and condition of replacement motors being maintained by each user; and determining the motor and position requirements of the driven apparatus;
transferring the replacement motors to one or more climate controlled storage locations so as to be made available at least to the user that owns each motor, the motors of disparate users who agree to share motors constituting a replacement inventory for users of like motors;
maintaining, in addition to replacement motors of the users, an inventory of new or rebuilt motors in the storage location in sufficient numbers that the new or rebuilt motors, in addition to the replacement motors of the users, are sufficient to satisfy the reasonably anticipated needs of all of the users for repaired or replacement motors;
providing transition bases for the replacement motors, such that a replacement motor can be supplied along with a transition base that matches the specifications of the replacement motor with the specifications of the driven apparatus, so that the drive shaft and driven shaft thereof can be coupled together; and
providing a replacement motor and transition base, to the extent required, in exchange for a motor needing repair or replacement, with the removal of the motor requiring repair or replacement being performed at the same time that the replacement motor is being transferred to the user's location, whereby the speed of motor exchange is enhanced and the inventory of replacement parts and replacement motors is minimized, and the motors are stored and maintained by specialists in the repair, rebuilding, and storage of motors.
